(19) United States
(12) Patent Application Publication
(10) Pub. No.: US 2012/0030306 A1
(43) Pub. Date: Feb. 2, 2012

(54) RAPID MOVEMENT SYSTEM FOR VIRTUAL DEVICES IN A COMPUTING SYSTEM, MANAGEMENT DEVICE, AND METHOD AND PROGRAM THEREFOR

(76) Inventor: Nobuharu Kami, Tokyo (JP)

(21) Appl. No.: 13/258,915

(22) PCT Filed: Apr. 27, 2010
(86) PCT No.: PCT/JP2010/057470

§ 371 Date: Sep. 22, 2011

(30) Foreign Application Priority Data
Apr. 28, 2009 (JP) 2009-109083

(51) Int. Cl. G06F 15/167

(52) U.S. Cl. 709/213

(57) ABSTRACT

In a virtualized computer system having at least two computers connected via a network, the service suspension period while a virtual device is dynamically migrated from a first computer to a second computer is shortened.

When the virtual device is migrated from the first physical device to the second physical device, memory data existing in an area mapped in the main memory of the first physical device is mapped in a high-speed storage device that is made available to the first physical device. The memory data is copied into an area that is registered in the second physical device but is made unavailable to the second physical device. During a temporary halt of the virtual device, a possession right transferring process is performed by changing possession right information about availability and unavailability of the high-speed storage device so that the area is made unavailable to the first physical device and is made available to the second physical device, thereby dynamically changing settings so that the virtual device can be operated with the use of the arithmetic processing unit of the second physical device.

### TECHNICAL FIELD

The present invention relates to higher-speed migrations (rapid movement) of virtual devices in a computer system (computing system) formed with virtual devices in physical machines connected to one another via a network.

### BACKGROUND ART

In a system having virtual devices formed in physical devices, a technique is normally used for migrating a virtual device between different physical devices in accordance with the usage states of the physical devices (see Patent Literature 1, for example).

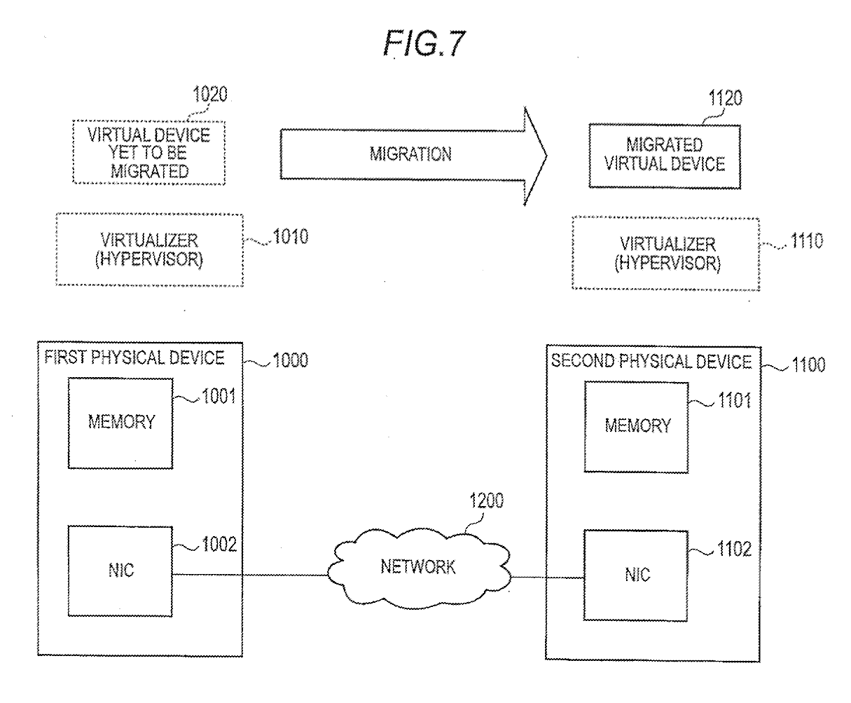

Non-Patent Literature 1 discloses an example of a technique concerning a higher-speed migration of a virtual device in a virtualized computer system formed with virtual devices as above. Referring to FIG. 7, this technique is described below.

As shown in FIG. 7, this virtualized computer system includes a first physical device 1000 and a second physical device 1100.

The first physical device 1000 includes a memory 1001 and a network interface card (NIC) 1002 for connecting physical devices. Likewise, the second physical device 1100 includes a memory 1101 and a network interface card 1102. The two devices are connected to each other by a network 1200 connected with switches and the like compliant with Ethernet (a registered trade name), for example. The two devices also include a virtualizer 1010 and a virtualizer 1110 such as Hyper visors.

Next, a case where a virtual device 1020 yet to be migrated such as a virtual machine is migrated from the first physical device 1000 to the second physical device 1100 is described. In the drawing, the virtual device 1020 yet to be migrated is shown by a dashed line, and a migrated virtual device 1120 is shown by a solid line.

In the virtualized computer system illustrated in FIG. 7, the speed of a virtual device migration is increased by copying the data in the memory area 1001 of the physical device 1000 allocated to the virtual device 1020 yet to be migrated, at high speed, into the memory 1101 allocated so that the migrated virtual device 1120 operates in the physical device 1100.

The copying is performed through a data transfer between the virutalizers 1010 and 1110 over the network 1200. Normally, such a transfer is performed by a highly-reliable data transfer method such as TCP (Transmission Control Protocol). However, the period of time required for the transfer depends on the amount of data to be transferred, the overhead caused by the network bandwidth and the protocol processing, and the speed of memory reading and writing, for example. In a specific example, a data transfer via a network protocol normally involves copying of more than one set of data, and therefore, there exists not only an overhead caused by protocol processing but also an overhead caused by data copying (at least copying of data from a network interface into a buffer area and then copying of data from the buffer area into the corresponding memory area in the virtual device).

Before this transfer is completed, the operation of the virtual device needs to be suspended. Therefore, the period of suspension is preferably minimized.

For example, according to Non-Patent Literature 1, to shorten the period of suspension, not all the memory data is copied, but only sequentially-rewritten memories are transferred (hereinafter, such memories will be referred to as “dirty memory” where appropriate). When the transfer efficiency and the rewrite rate are balanced with each other, the virtual device is stopped. After that, the last copying is performed, and the virtual device is then activated in the destination physical device. Through such a process, the time required for a migration can be shortened.

### CITATION LIST

### {Patent Literature}

{PTL 1} JP-A-2008-217302

### {Non-Patent Literature}

{NPTL 1} Christopher Clark, et al., “Live Migration of Virtual Machines” in Proceedings of the 2nd ACM/USENIX Symposium on Networked Systems Design and Implementation (NSDI 101), (online) (searching on Apr. 20, 2009), Internet {URL: http://www.cl.cam.ac.uk/netos/papers/101-migration-nsdi-pre.pdf>

### SUMMARY OF INVENTION

### Technical Problem

By the technique disclosed in Non-Patent Literature 1, the amount of data to be copied that determines the period of a temporary halt of a virtual device is reduced. In a case where the technique disclosed in Non-Patent Literature 1 is actually used, however, data copying is still performed via a network. Therefore, the service from the virtual device still needs to be suspended during a data transfer and a data copying operation using a highly-reliable network protocol. Furthermore, if rewriting is performed over a wide range, the overhead becomes significant.

That is, conventional techniques for migrating a virtual device between physical devices have the following two problems.

A first problem lies in the fact that there is a limit to the shortening of the period of service suspension accompanying a migration of a virtual device between different physical devices.

This is because, even if the amount of data to be copied is minimized, the data copying operation is still performed in the same manner, and extra time is invariably required for a transfer for copying and a processing overhead.

A second problem lies in the fact that the technique disclosed in Non-Patent Literature 1 or the like might show only a small effect, depending on the type of application executed in the virtual device.

This is because, if an application that involves rewriting of memories in a wide range is being executed, the amount of dirty memory is large, and the transfer of the dirty memory requires a long period of time accordingly.

Therefore, the present invention aims to provide a high-speed virtual device migration system that is capable of migrating a virtual device between different physical devices at a high speed in a virtualized computer system. The present invention also aims to provide a high-speed virtual device migration method and program.

### Solution to Problem

According to the present invention, there is provided, as a first system, a high-speed virtual device migration system that migrates a virtual device among a plurality of physical devices in a virtualized computer system that includes the physical devices connected to one another via a network and a high-speed storage device that can be accessed by the physical devices,

wherein each of the physical devices includes a main storage and is capable of accessing an area in the high-speed storage device as well as the main storage, the area being allocated to each of the physical devices so that collisions are prevented at the time of access to the high-speed storage device,
each of the physical devices holds mapping information about logical memory address space information and physical memory address information, the logical memory address space information being generated based on storage areas provided by the main storage and the high-speed storage device, and
the virtual device being operated in one of the physical devices is migrated to another one of the physical devices via the high-speed storage device, the mapping information being used in the migration.

Further, there is provided, as a second system, a high-speed virtual device migration system which comprises:

when a virtual device is to be migrated from the first physical device to a second physical device; mapping memory data in a high-speed storage device available to the a first physical device, the memory data existing in an area mapped in a main storage of the first physical device; copying the memory data into an area that is registered in the second physical device but is made unavailable to the second physical device; and during a temporary halt of the virtual device, performing a possession right transfer by changing possession right information about availability and unavailability of the high-speed storage device so that the area is made unavailable to the first physical device and is made available to the second physical device, thereby dynamically changing settings so that the virtual device can be operated with the use of an arithmetic processing unit of the second physical device.

Further, there is provided, as a first device, a management device for migrating a virtual device among a plurality of physical devices, the management device managing the physical devices connected to one another via a network and a high-speed storage device that can be accessed by the physical devices, the management device comprising:

allocating a storage area of the high-speed storage device exclusively to each of the physical devices so that collisions are prevented at the time of access; when the virtual device is migrated from a first one of the physical devices to a second one of the physical devices; mapping memory data in a storage area of a high-speed storage device available to the first physical device, the memory data existing in an area mapped in a main storage of the first physical device; copying the memory data into the storage area of the high-speed storage device that is registered in the second physical device but is made unavailable to the second physical device; during a temporary halt of the virtual device, performing a possession right transfer by changing possession right information about availability and unavailability of the high-speed storage device so that the storage area is made unavailable to the first physical device and is made available to the second physical device, thereby dynamically changing settings so that the virtual device can be operated with the use of an arithmetic processing unit of the second physical device.

Further, there is provided, as a first method, a high-speed virtual device migration method for migrating a virtual device among a plurality of physical devices in a virtualized computer system that includes the physical devices connected to one another via a network and a high-speed storage device that can be accessed by the physical devices,

wherein each of the physical devices includes a main storage device and is capable of accessing an area in the high-speed storage device and the main storage, the area being allocated to each of the physical devices so that collisions are prevented at the time of access to the high-speed storage device,
each of the physical devices holds mapping information about logical memory address 1.0 space information and physical memory address information, the logical memory address space information being generated based on storage areas provided by the main storage device and the high-speed storage device, and
the virtual device being operated in one of the physical devices is migrated to another one of the physical devices via the high-speed storage device, the mapping information being used in the migration.

Further, there is provided, as a second method, a high-speed virtual device migration method, comprising:

when a virtual device is to be migrated from the first physical device to a second physical device; mapping memory data in a high-speed storage device available to the a first physical device, the memory data existing, in an area mapped in a main storage device of the first physical device; copying the memory data into an area that is registered in the second physical device but is made unavailable to the second physical device; and during a temporary halt of the virtual device, performing a possession right transfer by changing possession right information about availability and unavailability of the high-speed storage device so that the area is made unavailable to the first physical device and is made available to the second physical device, thereby dynamically changing settings so that the virtual device can be operated with the use of an arithmetic processing unit of the second physical device.

Further, there is provided, as a third method, a management method for migrating a virtual device among a plurality of physical devices, the management method managing the physical devices connected to one another via a network and a high-speed storage device that can be accessed by the physical devices, the management method comprising: allocating a storage area of the high-speed storage device exclusively to each of the physical devices so that collisions are prevented at the time of access; when the virtual device is migrated from a first one of the physical devices to a second one of the physical devices, mapping memory data in a storage area of a high-speed storage device available to the first physical device, the memory data existing in an area mapped in a main storage device of the first physical device; copying the memory data into the storage area of the high-speed storage device that is registered in the second physical device but is made unavailable to the second physical device; and during a temporary halt of the virtual device, performing a possession right transfer by changing possession right information about availability and unavailability of the high-speed storage device so that the storage area is made unavailable to the first physical device and is made available to the second physical device, thereby dynamically changing settings so that the virtual device can be operated with the use of an arithmetic processing unit of the second physical device.

Further, there is provided, as a first program, a high-speed virtual device migration program for migrating a virtual device among a plurality of physical devices in a virtualized computer system that includes the physical devices connected to one another via a network and a high-speed storage device that can be accessed by the physical devices; the high-speed virtual device migration program causing a computer to function as the computer system,

wherein each of the physical devices includes a main storage and is capable of accessing an area in the high-speed storage device as well as the main storage, the area being allocated to each of the physical devices so that collisions are prevented at the time of access to the high-speed storage device,
each of the physical devices holds mapping information about logical memory address space information and physical memory address information, the logical memory address space information being generated based on storage areas provided by the main storage and the high-speed storage device, and
the virtual device being operated in one of the physical devices is migrated to another one of the physical devices via the high-speed storage device, the mapping information being used in the migration.

Further, there is provided, as a second program, a high-speed virtual device migration program causing a computer to function as a computer system to: when a virtual device is to be migrated from the first physical device to a second physical device; map actual memory data in a high-speed storage device available to the a first physical device, the memory data existing in an area mapped in a main storage of the first physical device; copy the memory data into an area that is registered in the second physical device but is made unavailable to the second physical device; and during a temporary halt of the virtual device, perform a possession right transfer by changing possession right information about availability and unavailability of the high-speed storage device so that the area is made unavailable to the first physical device and is made available to the second physical device, thereby dynamically changing settings so that the virtual device can be operated with the use of an arithmetic processing unit of the second physical device.

Further, there is provided, as a third program, a management program for migrating a virtual device among a plurality of physical devices, the management program managing the physical devices connected to one another via a network and a high-speed storage device that can be accessed by the physical devices, the management program causing a computer to function as a management device to: allocate a storage area of the high-speed storage device exclusively to each of the physical devices so that collisions are prevented at the time of access; when the virtual device is migrated from a first one of the physical devices to a second one of the physical devices, map memory data in a storage area of a high-speed storage device available to the first physical device, the memory data existing in an area mapped in a main storage of the first physical device; copy the memory data into the storage area of the high-speed storage device that is registered in the second physical device but is made unavailable to the second physical device; and during a temporary halt of the virtual device, perform a possession right transfer by changing possession right information about availability and unavailability of the high-speed storage device so that the storage area is made unavailable to the first physical device and is made available to the second physical device, thereby dynamically changing settings so that the virtual device can be operated with the use of an arithmetic processing unit of the second physical device.

### Advantageous Effects of Invention

According to the present invention, a data copying operation is not performed. Instead, a high-speed storage device that is set separately from main memories is shared between physical devices, and an operation to transfer the right of possession to a specific area between the physical devices is performed with the use of the high-speed storage device that is capable of dynamically setting the right of possession to the specific area. Accordingly, a virtual device can be migrated between different physical device at a high speed, and the service suspension period accompanying the migration can be shortened.

### BRIEF DESCRIPTION OF DRAWINGS

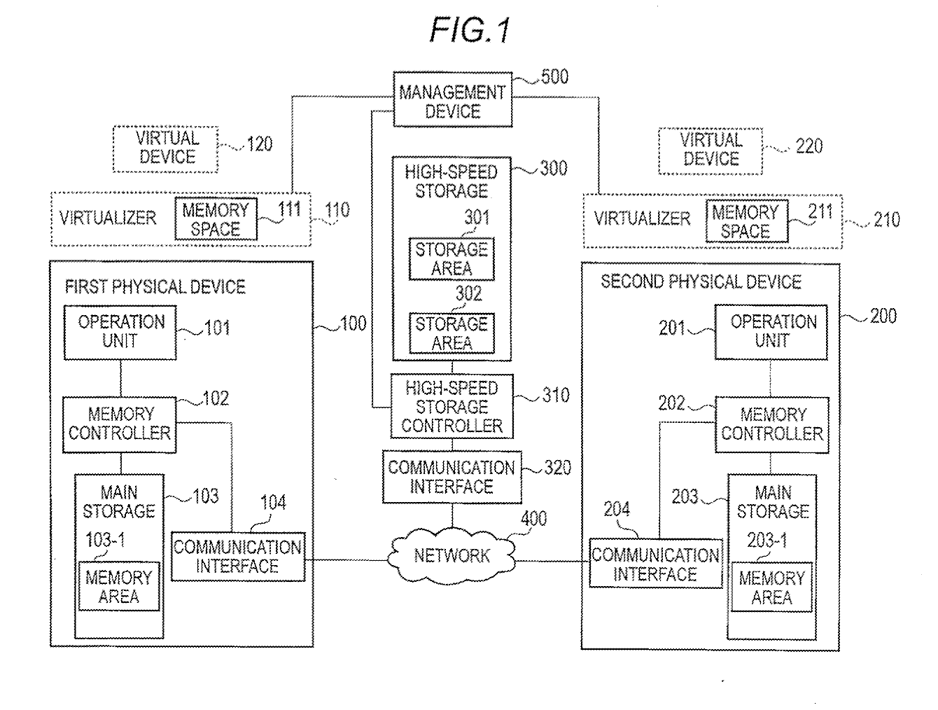

{FIG. 1} A block diagram shows the structure of an embodiment for carrying out the invention.

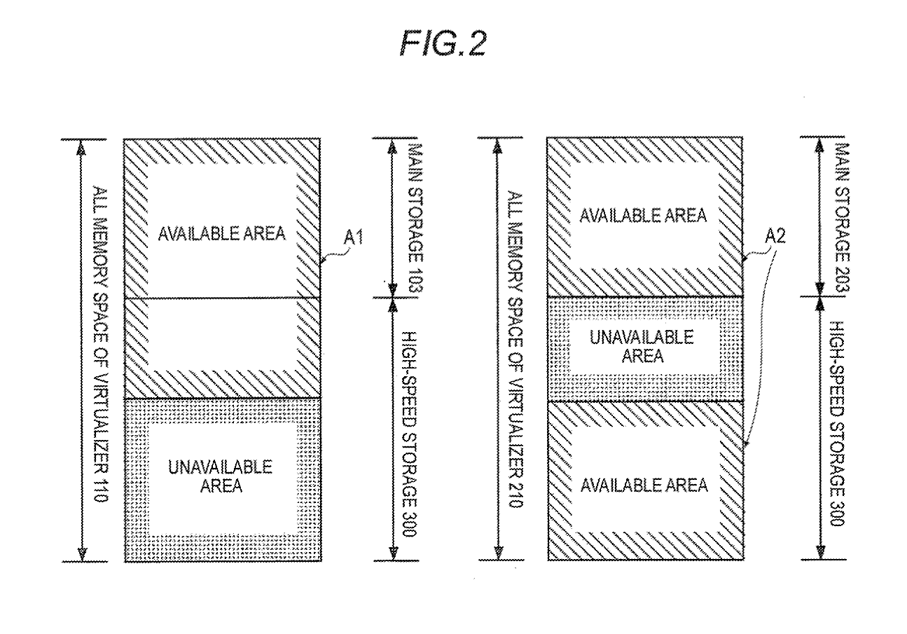

{FIG. 2} A schematic view shows example settings of the memory spaces held by virtualizers in the embodiment for carrying out the invention.

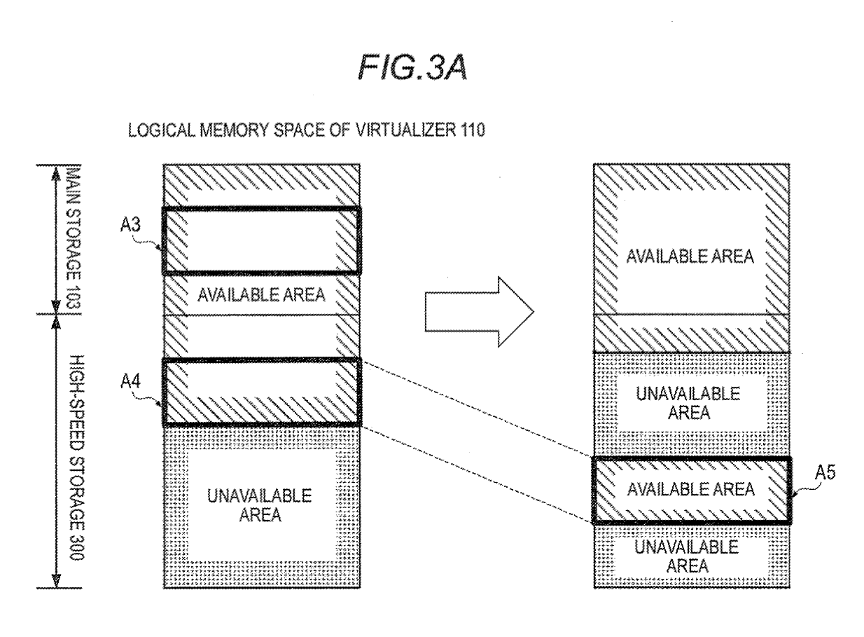

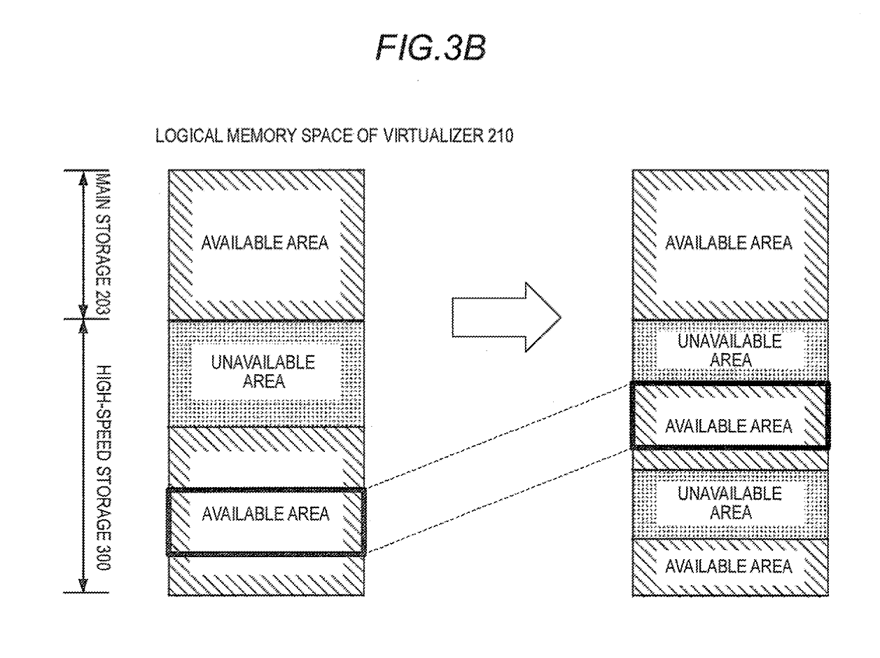

{FIG. 3A} The first half of a schematic view shows a process to transfer the right of possession to an area allocated to a virtual device in the memory spaces held by the virtualizers in the embodiment for carrying out the invention.

{FIG. 3B} The second half of the schematic view shows the process to transfer the right of possession to an area allocated to a virtual device in the memory spaces held by the virtualizers in the embodiment for carrying out the invention.

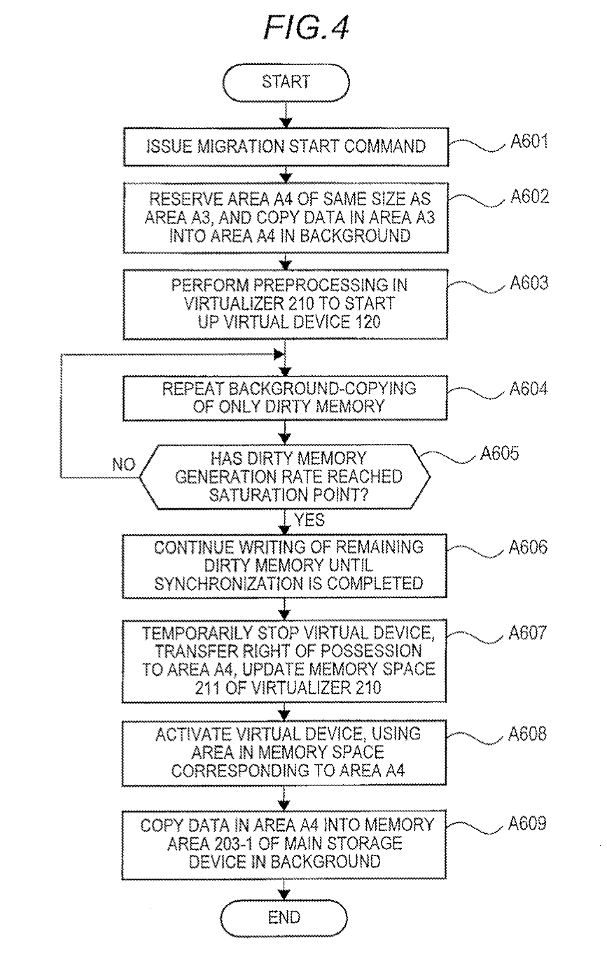

{FIG. 4} A flowchart shows an operation according to the embodiment for carrying out the invention.

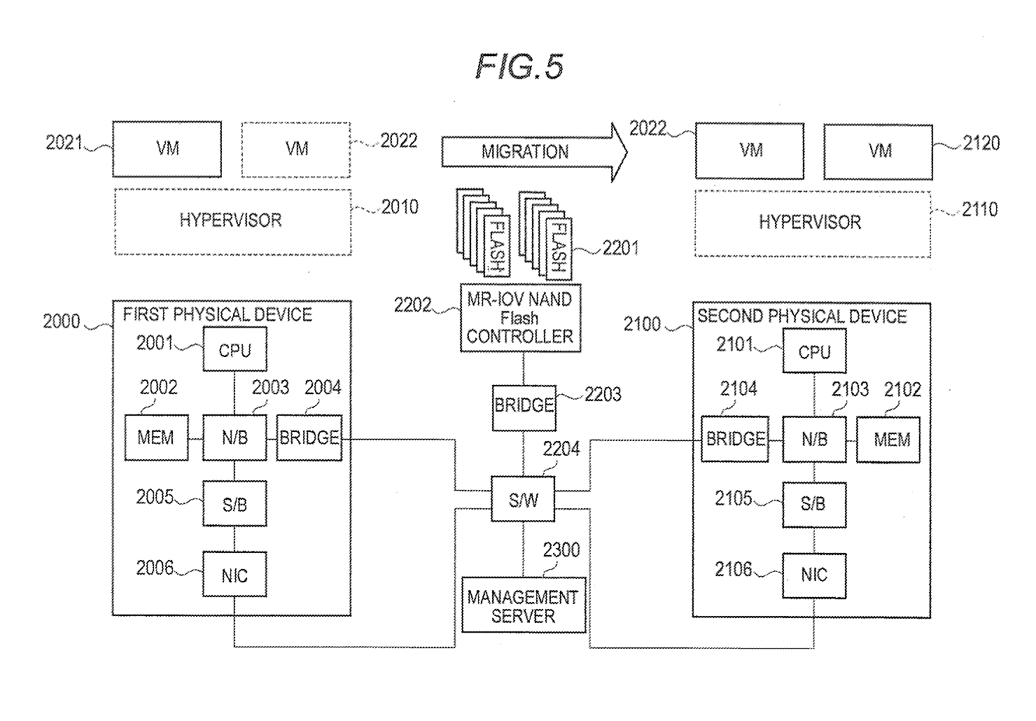

{FIG. 5} A block diagram shows the structure of Example 1.

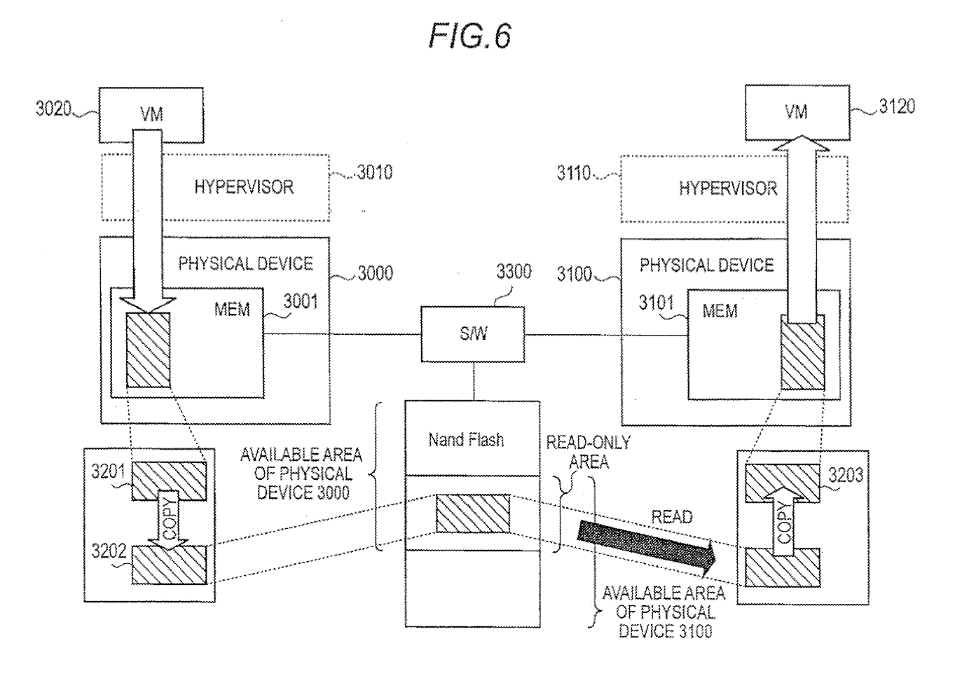

{FIG. 6} A block diagram shows the structure of Example 2.

{FIG. 7} A block diagram shows an example structure according to a technique related to the present invention.

### REFERENCE SIGNS LIST

100, 1000, 2000 first physical devices
101, 201 operation units
102, 202 memory controllers
103, 203 main storages
103-1, 203-1 memory areas
104, 204, 320 communication interfaces
110, 210 virtualizers
111, 211 memory spaces
120, 220 virtual devices
200, 1100, 2100 second physical devices
300 high-speed storage
301, 302 storage areas
310 storage device controller
400, 1200 networks
500 management device
1001, 1101 memories
1002, 1102 network interface cards
1010, 1110 virtualizers
1020 virtual device yet to be migrated
1021 migrated virtual device
2001, 2101 CPUs
2002, 2102 main memories
2003, 2103 NORTHBRIDGEs
2004, 2104, 2203 Bridges
2005, 2105 SOUTHBRIDGEs
2006, 2106 network interface cards
2010, 2110 Hypervisors
2021, 2022, 2120 VMs
2201 NAND Flash
2202 MR-IOV NAND Flash controller
2204, 3300 network switch routers
2300 management server
3000, 3100 physical devices
3001, 3101 main memories
3010, 3110 Hypervisors
3020, 3120 Virtual Machines
3201, 3202, 3203 memory areas
A1, A2 available areas
A3, A4, A5 storage areas

### DESCRIPTION OF EMBODIMENTS

The following is a detailed description of embodiments for carrying out the invention, with reference to the accompanying drawings.

### DESCRIPTION OF CONFIGURATION

Referring to FIG. 1, an embodiment of the present invention includes a first physical device 100 and a second physical device 200.

The two physical devices 100 and 200 include operation units 101 and 201, memory controllers 102 and 202, main storages 103 and 203, and communication interfaces 104 and 204, respectively.

The operation units 101 and 201 are arithmetic processing units such as CPUs. The memory controllers 102 and 202 are devices that control main storage devices, and are typically mounted on chipsets. The main storages 103 and 203 are the main storage devices, and include memory areas 103-1 and 203-1 as storage areas, respectively. The communication interfaces 104 and 204 are interfaces for performing communications between devices.

The two physical devices 100 and 200 further include virtualizers 110 and 210. The virtualizers 110 and 210 are programs to be executed in the respective physical devices 100 and 200, and are typically hypervisors, for example.

The two physical devices 100 and 200 further include virtual devices 120 and 220 that are created and operated by the respective virtualizers 110 and 210.

The embodiment of the present invention further includes a high-speed storage 300 mounted outside the two physical devices 100 and 200, a high-speed storage controller 310 serving as the controller of the high-speed storage 300, and a communication interface 320 that is the communication interface to be used by the high-speed storage 300 and the high-speed storage controller 310. The high-speed storage 300 includes a storage area 301 and a storage area 302 as the storage areas.

The first physical device 100, the second physical device 200, the high-speed storage controller 310, and the high-speed storage 300 are connected to one another via the above described communication interfaces and a network 400. A specific example of the communication method used in this embodiment is Ethernet (a registered trade name). However, the communication method in this embodiment is not particularly limited to a specific communication method, and may be any communication method.

This embodiment further includes a management device 500 connected to the virtual device 120 and the virtual device 220 via a network.

The structure illustrated in FIG. 1 is merely an example of an embodiment, and various modifications may be made to the structure. For example, the memory controllers 102 and 202 may be mounted on sites other than the chipsets. The memory controllers 102 and 202 may be mounted inside the operation units 101 and 201, instead of on the chipsets.

Further, the high-speed storage 300 and the high-speed storage controller 310 are not necessarily located outside the two physical devices 100 and 200, and may be mounted inside the housing of one of the physical devices 100 and 200.

This block diagram only shows a general logical relationship, and the physical connections are not limited to those illustrated in the block diagram. Further, communications between the management device 500 and the virtualizers 110 and 210, and between the management device 500 and the high-speed storage controller 310 may be made via the network 400, but do not need to be made via the network 400.

The above respective components operate as follows.

The operation units 101 and 201 perform arithmetic operations, executing various programs.

The main storages 102 and 202 are storage devices such as DRAMs. Each physical device includes at least one main storage. The main storages 102 and 202 are normally mounted near the operation units 101 and 201, and perform extremely-high-speed data communications with the operation units 101 and 201.

The communication interfaces 104 and 204 perform network protocol processing so that the memory controllers 102 and 202 and the high-speed storage controller 310 can communicate with one another over the network 400 even if the memory controllers 102 and 202 and the high-speed storage controller 310 are located at a long distance from one another.

The network 400 represents a network formed with switching routers and the like compliant with Ethernet, and enables data transmission and reception between end points. This data communication preferably maintains reliability. Therefore, when a packet is discarded, the packet is resent, and the transmission rate is controlled to restrain convergence. Such functions are preferably realized in the form of hardware.

The function to realize the above processing may be mounted in the communication interfaces 104 and 204, or may be mounted in both the network 400 and the communication interfaces 104 and 204. The former case can be realized by installing a function compliant with TCP on each end point, for example. The latter case can be realized where a mechanism for preventing packet discarding by a credit method is installed in the network, and the function to control the transmission rate based on a convergence degree signal from the network is installed on each end point. However, specific configurations are not limited to the above, as long as the same functions as above can be realized.

The high-speed storage 300 is a device that can perform high-speed data writing and reading, such as a NAND flash memory (hereinafter referred to as “NAND Flash” where appropriate), a DRAM, or a SRAM. That is, the high-speed storage 300 is a device that operates at a much higher speed than other devices such as hard disks, but operates at least at the same speed or a slightly lower speed than the main storage devices.

The high-speed storage controller 310 performs setting and control so that the operation units 101 and 201 can safely access the high-speed storage 300. The essential feature described in the description of this embodiment is the method of managing the storage areas of the high-speed storage 300. However, this does not mean that the components of this embodiment is limited to those involved in the method of managing the storage areas of the high-speed storage 300.

The memory controllers 102 and 202 are units that manage the correspondence between the addresses in the memory spaces managed by software having administrative authority such as operation systems like the virtualizers 110 and 210, and the physical addresses of actual physical storage devices.

The virtual devices 120 and 220 are computer devices that are managed by the virtualizers 110 and 210, and are provided with virtual resources. Management software and application processes such as operation systems are operated in the computer devices.

The management device 500 mainly manages the settings of the virtualizers 110 and 210 and the high-speed storage controller 310.

In the following description, the first physical device 100 and the second physical device 200 including the software programs to be executed therein will be referred to as a first computer 1 and a second computer 2, respectively. Also, a SAN (Storage Area Network), a NFS (Network File System), and the like are used as a disk device, and are shared between the two computers 1 and 2.

### DESCRIPTION OF OPERATIONS

Referring now to FIGS. 1, 2, 3A, and 3B, and the flowchart shown in FIG. 4, the entire operation according to this embodiment is described in detail.

1. Process Settings

First, a method of forming the memory spaces to be managed by the virtualizers 110 and 210 when the first computer 1 and the second computer 2 are activated is described before the operation to be performed at the time of a migration is described. The concept of a memory allocation according to this embodiment is also described herein.

The memory space 111 of the first computer 1 is formed with the main storage 103 and the high-speed storage 300. When an input/output (I/O) device is recognized at the time of activation of a virtualizer, the input/output device can normally map the address for accessing the register, and make the access from the operation unit, like the main storage. In this embodiment, the high-speed storage 300 maps all the areas (the areas 301 and 302 in the example illustrated in FIG. 1) in the same manner as above.

If 64-bit operating systems are used, it is theoretically possible to form 16-EB areas as memory areas. In this aspect, currently available operating systems are normally designed to be able to have several terabytes of memory space, for example.

In this description, the area 301 that is part of the high-speed storage 300 is allocated exclusively to the first computer 1, and the area 302 is allocated exclusively to the second computer 2. The allocation is realized by providing attributes of available areas and unavailable areas in the memory spaces, as illustrated in FIG. 2. For example, the portion corresponding to the area 301 is set as an available area in the memory space of the first computer 1, and is set as an unavailable area in the second computer 2, when the computers 1 and 2 are activated by an instruction from the management device 500. In FIG. 2, an area A1 is an available area, and all the main storage 102 and the area 301 of the high-speed storage 300 are set as the available area A1 in the memory space of the virtualizer 110, for example. When allocating memory spaces to the virtual devices, the virtualizer 110 uses only the available area, and does not use the unavailable area.

Likewise, in the memory space of the virtualizer 210, the portion corresponding to the storage area 302 and the portion corresponding to the main storage device are set as available areas (equivalent to the areas A2 in the drawing), and the rest is set as an unavailable area.

Since translations between logical memory addresses and physical memory addresses normally need to be performed at high speeds, the memory controllers are realized by hardware circuit devices. If an unavailable area is accessed, an exception is thrown, and access to areas other than available areas is prohibited, to ensure secure usage between computers. The high-speed storage controller 310 may be compliant with an input/output (IO) virtualizing function in a virtualizing system such as IOV (I/O Virtualization) specified by PCI-SIG. As the IO virtualizing function is employed, it is possible to manage the areas allocated to the respective virtual devices with ease, and realize high-speed and safe device sharing, as is assumed in this description. However, specific configurations are not limited to the above, as long as the same functions as above can be realized.

{Migrating Operation}

Referring now to the flowchart shown in FIG. 4 and the conceptual diagrams shown in FIGS. 3A and 3B, an operation to be performed at the time of a migration according to the present invention is described in detail.

As mentioned above, the present invention aims to provide a method of shortening the time required for a memory transfer and copying between main storages at the time of a migration. The memory transfer and the copying are the reasons why services being provided by a virtual device are stopped. In the following, the operation flow is described sequentially. Prior to a migration, an available memory area A3 in the memory space 111 is allocated to the virtual device 120 from the portion corresponding to the main storage (equivalent to the area 103-1 in FIG. 1).

First, when the management device 500 or the virtualizer 110 directly receives an operation, a migration start command is issued (step S601).

An area A4 that has the same size as the area A3 is reserved in the available area in the portion corresponding to the high-speed storage 300, and the contents of the area A3 are copied into the area A4 in the background. During this time, the virtual device 120 does not stop operating, and, if rewriting occurs after the copying is completed, the information is left as a “dirty memory” (step S602).

To shorten the period of service suspension as much as possible, the preprocessing for starting up the virtual device 120 is performed in the virtualizer 210 that is the migration destination (step S603). This process varies depending on the implementation. However, in the case of a virtualizer such as Xen, the process is normally the general setting required for activating a new virtual device such as a resource allocation to the virtual device (the parameters for a memory area allocation and a CPU resource distribution, for example). The data in the memory is currently replaced with the data stored in the memory space of the first computer 1. However, the virtual device is not activated at least until the overwriting is completed, and only a “box” for the virtual device is formed in a metaphorical sense. In this description, only the memory areas essential in this embodiment are described. A memory area of the same size as the memory area allocated to the virtual device to be migrated is reserved. The reserved memory is the area 203-1 of the main storage 203.

After the data synchronization process of step S602 is once completed, only the dirty memory is again copied in the background (step S604).

Since the amount of the dirty memory keeps decreasing at first, sequential copying is repeated (No in step S605, step S604). However, if the sequential copying is repeated, memory updating occurs at a certain rate (frequency), as long as the copying period is limited, and the virtual device is operating. Therefore, the sequential copying amount stops conspicuously decreasing. When the saturation point is reached (Yes in step S605), the operation moves on to step S606. The saturation point may be determined by comparing the rate of change in the copying amount of the dirty memory with a predetermined value, but may be determined by some other technique.

As for the memory writing in the virtual devices thereafter, writing is performed on the main storage 102 and the high-speed storage 300 at the same time, to synchronize the main storage 102 and the high-speed storage 300 with each other. Writing of the remaining dirty memory is continued until the virtual device data areas of the main storage 102 and the high-speed storage 300 are completely synchronized with each other (step S606).

When the synchronizing process is finished, the virtual device is temporarily stopped, and the area A4 is made unavailable in the first computer 1, and is made available in the second computer 1 (step S607). To store the total memory size to be allocated to the computers, the high-speed storage controller 310 may prepare an area A5 of the same size as the area A4 currently available in the second computer 2, as illustrated in FIGS. 3A and 3B, and interchange those areas. However, this technique is merely an example, and is not necessarily used. For example, the high-speed storage controller 310 may present the addresses indicating a virtual storage device area, instead of a physical address, to the computers. In this case, the high-speed storage controller 310 manages the correspondence table showing actual physical addresses and virtual addresses, and rewrites the table. The high-speed storage controller 310 can also perform the interchange in this manner.

The virtualizer 210 activates a virtual device, using the area corresponding to the area A4 in the memory space. For example, this aspect can be realized by setting the memory controller 202 so that the physical address of the area A4 of the high-speed storage 300 is used for all accesses to the memory area 203-1 designated through the preprocessing of step 5603 (step S608).

In the background, the data in the storage area A4 is copied into the memory area 203-1 of the main storage 203 (step S609). This copying is performed by sequentially copying the dirty memory in the same manner as in steps S604 and S605, and performing mapping of a logical memory address and a physical memory address so that the area 203-1 is used, after the simultaneous writing is appropriately performed on the high-speed storage 300 and the main storage 203, and the area A4 and the area 203-1 are completely synchronized with each other.

Next, the effects of this embodiment are described.

In this embodiment, when virtual device memory data is migrated from the first computer 1 to the second computer 2, the migration is realized only by performing a memory writing process directly on the high-speed storage 300 and replacing the subject area, instead of performing a copying process using a network protocol. Accordingly, unnecessary protocol processing and copying can be eliminated, and a migration of a virtual device can be realized at a higher speed.

The virtual device is completely stopped only while the right of possession to the subject area in the high-speed storage 300 is transferred from the first computer 1 to the second computer 2. Accordingly, an overhead is not caused by a data transfer performed by copying data from the first computer 1 into the second computer 2 over a network after the saturation point of the dirty memory generation rate is reached as in conventional cases.

That is, in a conventional transfer using TCP, for example, data is copied into a transmission buffer on the transmitting end, and TCP protocol processing is performed to copy data divided into segments into a NIC register. The copied data is then transmitted over a network. During the transmission, an ACK process is performed, and, if the packet is discarded, the packet is resent. On the receiving end, received data is copied into a reception buffer when an interrupt from the NIC occurs, and the data is copied and transferred to the corresponding receiving process.

In those processes in this embodiment, on the other hand, the portions related to highly-reliable transfers are turned into hardware by the communication interfaces 104 and 204, and the overhead due to protocol processing can be eliminated. Also, unnecessary data copying for using a network protocol can be eliminated.

The processing speed of the virtual device during the period between a point immediately before the last dirty memory copying and the end of the area replacement depends on the speed of access to the high-speed storage 300. However, this dirty memory copying is direct writing from an operation unit. This is performed through the same process as the process for copying data into a different memory address. Therefore, a processing overhead as above does not occur, and moreover, the virtual devices do not need to be stopped.

In this embodiment of the present invention, when a virtual device is migrated, a series of processes is divided into the writing of the last dirty memory into the high-speed storage 300, the transfer of the right of possession, and the writing from the dirty data in the high-speed storage 300 into the main storage. A flexible migration of a virtual device in accordance with the loading factor and the dirty memory (data) generation rate at present is performed, and accordingly, the period of continuous service suspension and the processing speed of the virtual device can be managed in a flexible manner. Depending on the characteristics of the program being executed in a virtual device, the operation speed of the high-speed storage 300 might be slow, and the dirty memory generation rate might be very high, for example. In such a case, the virtual device is temporarily stopped, and only after the last dirty memory is migrated, the virtual device is restarted. After all the preparations for a transfer process are made, only the transfer of the right of possession is performed. In this manner, management can be performed in accordance with each situation. Likewise, a migration from the high-speed storage 300 to the main storage 203 can be performed when necessary. Accordingly, a migration process can be performed, with the present loading rate, the dirty memory generation rate, and the access speed being taken into account. Further, in this description, the area allocation to the high-speed storage 300 is performed exclusively between the first computer 1 and the second computer 2. However, since a reading process does not destroy data, reading from the second computer 2 into the area A4 (the area 301 in FIG. 1) may be allowed until immediately before the transfer, and data is also copied into the memory area 203-1, so as to the processing speed even further.

### EXAMPLE 1

Next, an operation of an embodiment for carrying out the present invention is described through a specific example.

FIG. 5 shows Example 1. As illustrated in FIG. 5, a first physical device 2000 and a second physical device 2100 include CPUs 2001 and 2101, NICs (Network Interface Cards) 2006 and 2106, SOUTHBRIDGEs 2005 and 2105, NORTHBRIDGEs 2003 and 2103, main memories 2002 and 2102, and Bridges 2004 and 2104, respectively. Hypervisors 2010 and 2110 such as Xen and VMWare operate in the first physical device 2000 and the second physical device 2100, to form a VM (Virtual Machine) 2022 that is being operated.

It should be noted that the VM 2022 is currently being operated in the physical device 2000, and, after a migration, will be operated in the physical device 2100. To make this aspect clear in the drawing, the VM 2022 in the physical device 2000 is shown by a dashed line, and the VM 2022 in the physical device 2100 after a migration is shown by a solid line.

A management server 2300, a Bridge 2203, the NICs 2006 and 2106 are connected to a switch 2204, and can communicate with one another. This network is typically a network such as Ethernet, but is not limited to that. In this example, the Bridges perform PCIe-Ethernet protocol conversions so that all the components are connected by the single network switch 2204. When the management server 2300 accesses a Hypervisor, the NIC 2006 or 2106 is used. When the management server 2300 accesses a Bridge or a MR-IOV PCIe controller, a Bridge is used. However, this configuration is merely an example, and may be formed with different networks. The management server 2300 and the switch 2204 are also accessible, and the settings for the access can be changed. Also, the Bridges may have a transmission rate control function such as ECN, BCN, or QCN, and may have the function to detect a loss of a packet and resend the packet. Other than that, a mechanism that functions to control the rate and prevents packet losses by a transmission/reception method such as PAUSE or a credit method is preferably incorporated into the network. Further, the Bridges may cooperate with each other in highly-reliable communications such as transmission rate control and resending control by using signals and the like from the network, or may perform completely end-end control. It is preferably that a high-speed, high-reliability data transfer function is incorporated into the hardware in a transparent manner to management program such as the Hypervisors and the CPUs. However, the present invention is not limited to the above technique, as long as packet losses are certainly prevented.

Further, in this example, a MR-IOV NAND Flash controller 2202 that is a PCIe controller compatible with MR-IOV (Multi-Root I/O Virtualization) and NAND Flashes 2201 as high-speed storage devices are connected to the Bridge 2203.

Memory controllers are mounted in the NORTHBRIDGEs, and process high-speed signals involved in accesses and the like between Flashes via the CPUs, the main memories, and Bridges. Particularly, the NORTHBRIDGEs and the MR-IOV PCIe controller are connected by PCIe, and a high-speed area is preferably ensured so that the speed of communication therebetween is not much lower than the speed of access to the main memories, and communications between the NORTHBRIDGEs and the MR-IOV PCIe do not form bottlenecks. Here, the NORTHBRIDGEs 2003 and 2103 are recognized as Root Complexes in the PCIe network. In this example, MR-IOV is used. Alternatively, SR-IOV (Single Root IOV) may be used to achieve the same effect as above by dividing an address space with the Bridges and the network switch, and a function that allows operations with Root Complexes can be installed.

SOUTHBRIDGEs function as low-speed interfaces, and serve to connect I/O cards such as NICs to the CPUs and the like.

In this example, at the time of activation, the first physical device 2000 and the second physical device 2100 (including the first physical device 2000 and the second physical device 2100 as hardware, programs to be executed in the first physical device 2000 and the second physical device 2100, or combinations of those physical devices and the programs in this specification) set some or all of the NAND Flashes 2201 as the management devices for the first physical device 2000 and the second physical device 2100.

The management server 2300 determines beforehand how much area in each physical device is to be made visible to the NAND Flash controller 2202, and how much area in the visible area is to be allocated as an available area. When activated, each physical device registers the visible area as the management device therefor, and maps the visible area in the memory space. At the same time, the management server 2300 notifies each physical device of the available area in the visible area. With this arrangement, each Hypervisor recognizes which memory area can be allocated to respective programs and VMs, and performs attribute setting. Based on the information, the memory controller mounted in each NORTHBRIDGE monitors access. If there is a request for access to a prohibited area, each NORTHBRIDGE blocks such access, and informs the corresponding Hypervisor to that effect.

The same access management function as above is preferably installed in the NAND Flash controller, and the setting is preferably performed at the same time. By virtue of this function, direct access from the VMs to I/O devices is enabled, and accordingly, higher-speed processing can be performed. When activating a VM, each Hypervisor allocates a memory area to the VM, and the information is also sent to the NAND Flash controller. With the use of the function specified by MR-IOV, the area to be used by the VM is then set. With this arrangement, the area can be protected from direct access from the VM.

Next, a VM migrating operation is described in detail. When a VM migration command is issued from the management server 2300, the Hypervisor 2010 starts migrating a VM. Alternatively, an equivalent command may be input to the Hypervisor 2010 directly by a manager. The Hypervisor 2010 copies the memory area of the VM 2022 into the area in which NAND Flashes are mapped, in the same manner as that in the operation flow of the embodiment of the present invention shown in FIG. 4. The sequential copying is repeated as needed. When the dirty memory generation rate reaches the saturation point, the Hypervisor 2010 performs writing into the main memory in response to a memory writing process from the VM 2022, and also performs writing into a NAND Flash at the same time. The dirty memory copying is repeated in the background until the main memory and the NAND Flash are completely synchronized with each other. After the synchronization is completed, the VM 2022 accesses only the NAND Flash. At the same time, the Hypervisor 2110 prepares for activation of a new VM. At this point, the area in the NAND Flash to be used by the VM 2022 is made READ ONLY and visible to the second computer 2, and the information stored in the area is constantly sequentially copied into the area reserved in the main memory, to obtain synchronization. After the synchronization is completed, the VM 2022 is temporarily stopped when appropriate, while changes in loading rate are being monitored as needed. The available area and the unavailable area in the NAND Flash are updated in the same manner as in the above described embodiment. With this arrangement, access from the second computer 2 to the area of the VM 2022 is enabled, and the Hypervisor 2110 designates the physical address of the memory area of the newly created VM in the data portion of the high-speed storage device, to activate the new VM. At the same time, synchronization is obtained by copying the dirty memory into the area reserved in the main memory, and remapping is performed in the main memory area when appropriate. In this manner, the migration is completed.

In the processing flow shown in FIG. 4, it is possible to perform a migration step by step via a NAND Flash. However, when and how to migrate a VM depends on the operating state of the VM and the speed of access to a NAND Flash.

### EXAMPLE 2

Example 2 of the present invention concerns an application to construction of a backup server.

In a specific example, a physical device 3000 is set as a master server, and a physical device 3100 is set as a slave (backup) server, as shown in FIG. 6. A NAND Flash is shared through a network switch as in the above described embodiment, and is mapped in the logical memory spaces of the physical devices 3000 and 3100. The physical device 3000 and the physical device 3100 share the NAND Flash, and part of the available area of the physical device 3000 is also made available to the physical device 3100. However, the physical device 3100 can perform only reading from the overlapping area. A VM 3020 is operated in the physical device 3000, and the memory area 3201 for the VM 3020 is reserved in the main memory. Meanwhile, the dirty memory is constantly copied into an area 3202 mapped in the NAND Flash in the background, and this area 3202 is the area that can be also accessed from the physical device 3100 only for reading.

Meanwhile, a VM 3120 is operated in the physical device 3100, but the memory area for the VM 3120 is physically reserved in a main memory 3101 and is reserved as an area 3203 in the logical memory space. The physical device 3100 constantly copies the difference data (the dirty memory) from the readable area 3202 into the area 3203. Accordingly, the memory data of the YM 3020 is the same as the memory data of the VM 3120, except for the time required for the copying of the difference data. For example, even when a failure occurs in a device such as the CPU or the memory of the physical device 3000, the VM is immediately switched to the VM 3120 in the physical device 3100. In this manner, switching to the backup server can be performed instantly.

As a typical application, a system that performs processing on access from an external device such as a Web server can be considered. Such a server normally performs a new operation when accessed by a user. Even if the physical device 3000 breaks down, the operation is immediately switched to the physical device 3100, so that the user can continue to receive the service without noticing the trouble when the user makes the next access. If a failure occurs while a user access is being processed, the process related to the delay caused by writing of the difference data cannot be recovered. To counteract such a situation, an application program for aborting a process from which mismatch has been detected should be designed and installed. In this manner, problems can be prevented.

The above described embodiment and examples of the present invention have the following advantages.

A first advantage lies in the fact that a virtual device can be migrated between different physical devices at a high speed, and the period of service suspension during that time can be shortened.

This is because a conventional data copy method is not used. Instead, a high-speed storage device is shared between physical devices that are set separately from main memories, and the high-speed storage device can dynamically set the right of possession to a specific area, and transfer the right of possession to the area between the physical devices. The same effects as those obtained by the conventional data copy method can be achieved only through such a process.

A second advantage lies in the fact that the process required for achieving the first advantage is very simple.

This is because a remarkable change in software such as a virtualizer is not necessary, and the setting process accompanying the addition of a high-speed storage device can be readily automated. The dynamic processing necessary in an actual migration can also be performed by making a very simple change in the settings.

A third advantage lies in the fact that a migration process can be flexibly set so that the function to migrate a virtual device between different physical devices can be optimized.

This is because, according to the embodiment of the present invention, activating and stopping of a virtual device can be flexibly set based on the speed of access to a high-speed storage, the dirty memory generation rate, the loading rate in the virtual device, and the like.

A fourth advantage lies in the fact that device sharing can be realized compatibly between the host programs in different physical devices that do not even recognize the existence of each other.

As a technique related to the present invention, there is a suggested technique by which a so-called host program that can totally manage a device with respect to the sharing of an input/output device in a physical device is designed to update the mapping information about access to virtual computers under the control of the program. By such a technique, however, the host programs in different physical devices cannot compatibly share a device without recognizing the existence of each other.

In the present invention, on the other hand, the host programs being executed in different physical machines manage the mapping information about devices located in the network, and the management is not merely updating of the mapping information. Therefore, as described above, device sharing can be realized compatibly between host programs that do not even recognize the existence of each other.

It should be noted that the high-speed migration system for virtual devices as an embodiment of the present invention can be realized by hardware, but can also be realized by a computer reading and executing a program from a computer-readable recording medium. The program is designed for causing the computer to function as the high-speed migration system for virtual devices.

The method of migrating a virtual device at a high speed according to an embodiment of the present invention can be realized by hardware, but can also be realized by a computer reading and executing a program from a computer-readable recording medium. The program is designed for causing the computer to implement the method.

The above described embodiments are preferred embodiments and examples of the present invention, but the scope of the invention is not limited to those embodiments and examples. Various changes may be made to those embodiments and examples, without departing from the scope of the invention.

This application is based on Japanese Patent Application No. 2009-109083 (filed on Apr. 28, 2009), and claims priority under the Paris convention to Japanese Patent Application No. 2009-109083. The entire contents of Japanese Patent Application No. 2009-109083 are incorporated by reference into this specification.

Although representative embodiments of the present invention have been described, it should be understood that various changes, substitutions, and alternatives may be made without departing from the spirit and scope of the claimed invention. The inventor's intention is that, even if the claims are amended in the course of application procedures, the equivalent scopes of the claimed invention should be maintained.

The whole or part of the above described embodiments can be described as, but not limited to, the following supplementary notes.

(supplementary note 1) A high-speed virtual device migration system that migrates a virtual device among a plurality of physical devices in a virtualized computer system that includes the physical devices connected to one another via a network and a high-speed storage device that can be accessed by the physical devices,

wherein each of the physical devices includes a main storage and is capable of accessing an area in the high-speed storage device as well as the main storage, the area being allocated to each of the physical devices so that collisions are prevented at the time of access to the high-speed storage device,
each of the physical devices holds mapping information about logical memory address space information and physical memory address information, the logical memory address space information being generated based on storage areas provided by the main storage and the high-speed storage device, and
the virtual device being operated in one of the physical devices is migrated to another one of the physical devices via the high-speed storage device, the mapping information being used in the migration.

(supplementary note 2) The high-speed virtual device migration system according to supplementary note 1, wherein

each of the physical devices further includes a virtualizer that generates the virtual device, and
the virtualizer has a logical memory address space that is mapped in a physical address space formed with a physical address of the main storage and a physical address of the high-speed storage device.

(supplementary note 3) The high-speed virtual device migration system according to supplementary note 1 or 2, wherein,

in a memory address space area allocated to a virtual device, the mapping information about a physical address and logical address of the memory address space area is dynamically changed, and storage area possession information for access control is changed.

(supplementary note 4) The high-speed virtual device migration system according to any one of supplementary notes 1 through 3, wherein

the high-speed storage device is a storage device that operates at a slightly lower speed than the main storage or at the same speed or faster than the main storage, and is connected to a memory controller and an operation unit via a high-speed interface so as not to form a performance bottleneck, each of the physical devices further including the memory controller and the operation unit.

(supplementary note 5) The high-speed virtual device migration system according to any one of supplementary notes 1 through 4, further comprising a storage device controller that carries out control management of the high-speed storage device and controls access between the physical device and the high-speed storage device,

wherein the storage device controller manages a right of possession with respect to the access, the right being given to one of the physical devices sharing the high-speed storage device or the virtual device particularly in part of or all of storage area of the high-speed storage device.

(supplementary note 6) The high-speed virtual device migration system according to any one of supplementary notes 1 through 5, wherein

each of the physical devices manages the correspondence between the logical memory address and the physical memory address, using a NORTHBRIDGE in a chipset or a memory management unit installed in an operation device.

(supplementary note 7) The high-speed virtual device migration system according to any one of supplementary notes 1 through 6, wherein

a set of network switches is provided for communications through connections between the physical devices via the network, the set of network switches having a function to perform highly-reliable communications by controlling congestion based on queue management and reducing or nulling packet-discarding-rate in the connections.

(supplementary note 8) The high-speed virtual device migration system according to supplementary note 7, wherein

a bridge is provided to convert a first protocol specified for communications through connections via the network, and a second protocol specified for communications between the physical devices and the high-speed storage device, the connections via the network being transparent to a software program being executed in the physical devices.

(supplementary note 9) The high-speed virtual device migration system according to supplementary note 8, wherein

the bridge and the network switches cooperate with each other by using feedback signals from the network switches, the bridge and the network switches providing a reliability maintaining function to control a transmission rate and resend discarded packets.

(supplementary note 10) The high-speed virtual device migration system according to any one of supplementary notes 1 through 9, wherein

a computer different from the physical devices is connected to the same network as the network being used by the physical devices and the high-speed storage device to perform communications or another special-purpose network, and
the computer manages storage areas in computers containing the address mapping information, and manages timings of migrations of virtual devices.

(supplementary note 11) The high-speed virtual device migration system according to any one of supplementary notes 1 through 10, wherein

mapping of the address mapping information is performed when the computer system is activated, the high-speed storage device is read as an input/output device and is mapped in memory areas being managed by the physical devices, and in the mapping, a storage area allowing recognition and registration, and a storage area allowing recognition and registration but having unavailability as an attribute are set in each of the physical devices by using predetermined area allocation information.

(supplementary note 12) The high-speed virtual device migration system according to supplementary note 11, wherein

the type of the allowing is set in fine grain including only reading or reading and writing.

(supplementary note 13) The high-speed virtual device migration system according to any one of supplementary notes 1 through 12, wherein,

when an application program being executed in the physical devices or an application program functioning as the virtual device accesses an area not allowing access, the access is restricted.

(supplementary note 14) A high-speed virtual device migration system which comprises: when a virtual device is to be migrated from the first physical device to a second physical device; mapping memory data in a high-speed storage device available to the a first physical device, the memory data existing in an area mapped in a main storage of the first physical device; copying the memory data into an area that is registered in the second physical device but is made unavailable to the second physical device; and during a temporary halt of the virtual device, performing a possession right transfer by changing possession right information about availability and unavailability of the high-speed storage device so that the area is made unavailable to the first physical device and is made available to the second physical device, thereby dynamically changing settings so that the virtual device can be operated with the use of an arithmetic processing unit of the second physical device.

(supplementary note 15) The high-speed virtual device migration system according to supplementary note 14, wherein, while copying from the main storage to the high-speed storage device is being performed, the virtual device is not stopped, and a synchronizing process is performed by copying only sequentially-rewritten data in the background, when the amount of data rewritten within a period of time required for the copying is determined to have reached a saturation point, simultaneous writing is started not only in the main storage but also in the high-speed storage device in response to generation of a process to write data into the area from the virtual device at the same time as difference data copying, and when the synchronization is completed, the mapping of a logical address and a physical address is updated so that the main storage thereafter accesses the high-speed storage device, thereby causing the virtual device to continue to operate.

(supplementary note 16) The high-speed virtual device migration system according to supplementary note 14 or 15, wherein, after the possession right transfer is performed, a migrated virtual device that holds the same setting information as that in the virtual device yet to be migrated, and is newly activated in an operation unit in the second physical device accesses virtual device memory data in the high-speed storage device, to continue the same operation as that of the virtual device that is operated in the first physical device prior to the migration, and data is migrated from the high-speed storage device to the main storage of the second physical device in the same manner as in the migration of the virtual device from the first physical device to the second physical device, without a halt of the virtual device.

(supplementary note 17) The high-speed virtual device migration system according to any one of supplementary notes 14 through 16, wherein, prior to the possession right transfer, the area in the high-speed storage device into which the memory data of the virtual device to be migrated is sequentially written is switched from being unavailable to access from the second physical device to being available only for reading to access from the second physical device, thereby sequentially migrating data into a memory area reserved for the virtual device in the main storage of the second physical device.

(supplementary note 18) A management device for migrating a virtual device among a plurality of physical devices, the management device managing the physical devices connected to one another via a network and a high-speed storage device that can be accessed by the physical devices, the management device comprising: allocating a storage area of the high-speed storage device exclusively to each of the physical devices so that collisions are prevented at the time of access; when the virtual device is migrated from a first one of the physical devices to a second one of the physical devices; mapping memory data in a storage area of a high-speed storage device available to the first physical device, the memory data existing in an area mapped in a main storage of the first physical device; copying the memory data into the storage area of the high-speed storage device that is registered in the second physical device but is made unavailable to the second physical device; during a temporary halt of the virtual device, performing a possession right transfer by changing possession right information about availability and unavailability of the high-speed storage device so that the storage area is made unavailable to the first physical device and is made available to the second physical device, thereby dynamically changing settings so that the virtual device can be operated with the use of an arithmetic processing unit of the second physical device.

(supplementary note 19) The management device according to supplementary note 18, wherein, while copying from the main storage into the high-speed storage device is being performed, the virtual device is not stopped, and a synchronizing process is performed by copying only sequentially-rewritten data in the background, when the amount of data rewritten within a period of time required for the copying is determined to have reached a saturation point, simultaneous writing is started not only in the main storage but also in the high-speed storage device in response to generation of a process to write data into the area from the virtual device at the same time as difference data copying, and when the synchronization is completed, the mapping of a logical address and a physical address is updated so that the main storage thereafter accesses the high-speed storage device, thereby causing the virtual device to continue to operate.

(supplementary note 20) A high-speed virtual device migration method for migrating a virtual device among a plurality of physical devices in a virtualized computer system that includes the physical devices connected to one another via a network and a high-speed storage device that can be accessed by the physical devices,

wherein each of the physical devices includes a main storage device and is capable of accessing an area in the high-speed storage device and the main storage, the area being allocated to each of the physical devices so that collisions are prevented at the time of access to the high-speed storage device,
each of the physical devices holds mapping information about logical memory address space information and physical memory address information, the logical memory address space information being generated based on storage areas provided by the main storage device and the high-speed storage device, and
the virtual device being operated in one of the physical devices is migrated to another one of the physical devices via the high-speed storage device, the mapping information being used in the migration.

(supplementary note 21)A high-speed virtual device migration method, comprising: when a virtual device is to be migrated from the first physical device to a second physical device; mapping memory data in a high-speed storage device available to the a first physical device, the memory data existing in an area mapped in a main storage device of the first physical device; copying the memory data into an area that is registered in the second physical device but is made unavailable to the second physical device; and during a temporary halt of the virtual device, performing a possession right transfer by changing possession right information about availability and unavailability of the high-speed storage device so that the area is made unavailable to the first physical device and is made available to the second physical device, thereby dynamically changing settings so that the virtual device can be operated with the use of an arithmetic processing unit of the second physical device.

(supplementary note 22) A management method for migrating a virtual device among a plurality of physical devices, the management method managing the physical devices connected to one another via a network and a high-speed storage device that can be accessed by the physical devices, the management method comprising: allocating a storage area of the high-speed storage device exclusively to each of the physical devices so that collisions are prevented at the time of access; when the virtual device is migrated from a first one of the physical devices to a second one of the physical devices, mapping memory data in a storage area of a high-speed storage device available to the first physical device, the memory data existing in an area mapped in a main storage device of the first physical device; copying the memory data into the storage area of the high-speed storage device that is registered in the second physical device but is made unavailable to the second physical device; and during a temporary halt of the virtual device, performing a possession right transfer by changing possession right information about availability and unavailability of the high-speed storage device so that the storage area is made unavailable to the first physical device and is made available to the second physical device, thereby dynamically changing settings so that the virtual device can be operated with the use of an arithmetic processing unit of the second physical device.

(supplementary note 23) A high-speed virtual device migration program for migrating a virtual device among a plurality of physical devices in a virtualized computer system that includes the physical devices connected to one another via a network and a high-speed storage device that can be accessed by the physical devices, the high-speed virtual device migration program causing a computer to function as the computer system,

wherein each of the physical devices includes a main storage and is capable of accessing an area in the high-speed storage device as well as the main storage, the area being allocated to each of the physical devices so that collisions are prevented at the time of access to the high-speed storage device,
each of the physical devices holds mapping information about logical memory address space information and physical memory address information, the logical memory address space information being generated based on storage areas provided by the main storage and the high-speed storage device, and
the virtual device being operated in one of the physical devices is migrated to another one of the physical devices via the high-speed storage device, the mapping information being used in the migration.

(supplementary note 24) A high-speed virtual device migration program causing a computer to function as a computer system to: when a virtual device is to be migrated from the first physical device to a second physical device; map actual memory data in a high-speed storage device available to the a first physical device, the memory data existing in an area mapped in a main storage of the first physical device; copy the memory data into an area that is registered in the second physical device but is made unavailable to the second physical device; and during a temporary halt of the virtual device, perform a possession right transfer by changing possession right information about availability and unavailability of the high-speed storage device so that the area is made unavailable to the first physical device and is made available to the second physical device, thereby dynamically changing settings so that the virtual device can be operated with the use of an arithmetic processing unit of the second physical device.

(supplementary note 25) A management program for migrating a virtual device among a plurality of physical devices, the management program managing the physical devices connected to one another via a network and a high-speed storage device that can be accessed by the physical devices, the management program causing a computer to function as a management device to: allocate a storage area of the high-speed storage device exclusively to each of the physical devices so that collisions are prevented at the time of access; when the virtual device is migrated from a first one of the physical devices to a second one of the physical devices, map memory data in a storage area of a high-speed storage device available to the first physical device, the memory data existing in an area mapped in a main storage of the first physical device; copy the memory data into the storage area of the high-speed storage device that is registered in the second physical device but is made unavailable to the second physical device; and during a temporary halt of the virtual device, perform a possession right transfer by changing possession right information about availability and unavailability of the high-speed storage device so that the storage area is made unavailable to the first physical device and is made available to the second physical device, thereby dynamically changing settings so that the virtual device can be operated with the use of an arithmetic processing unit of the second physical device.

### INDUSTRIAL APPLICABILITY

The present invention can be used for changing settings through a high-speed migration of a virtual device in a system that includes at least two computers connected to each other via a network, such as a data center. The present invention can also be applied to a case where the area of virtual device information in a high-speed storage device is used as a backup server in a read-only mode in another computer.

1. A virtual device migration system that migrates a virtual device among a plurality of physical devices in a virtualized computer system that includes the physical devices connected to one another via a network and a storage device that can be accessed by the physical devices, wherein each of the physical devices includes a main storage and is capable of accessing an area in the storage device as well as the main storage, the area being allocated to each of the physical devices so that collisions are prevented at the time of access to the storage device,
each of the physical devices holds mapping information about logical memory address space information and physical memory address information, the logical memory address space information being generated based on storage areas provided by the main storage and the storage device, and
the virtual device being operated in one of the physical devices is migrated to another one of the physical devices via the storage device, the mapping information being used in the migration.

2. The virtual device migration system according to claim 1, wherein
each of the physical devices further includes a virtualizer that generates the virtual device, and
the virtualizer has a logical memory address space that is mapped in a physical address space formed with a physical address of the main storage and a physical address of the storage device.

3. The virtual device migration system according to claim 1, wherein,
in a memory address space area allocated to a virtual device, the mapping information about a physical address and logical address of the memory address space area is dynamically changed, and storage area possession information for access control is changed.

4. The virtual device migration system according to claim 1, wherein
the storage device is a storage device that operates at a slightly lower speed than the main storage or at the same speed or faster than the main storage, and is connected to a memory controller and an operation unit via an interface, each of the physical devices further including the memory controller and the operation unit.

5. The virtual device migration system according to claim 1, further comprising a storage device controller that carries out control management of the storage device and controls access between the physical device and the storage device, wherein the storage device controller manages a right of possession with respect to the access, the right being given to one of the physical devices sharing the storage device or the virtual device particularly in part of or all of storage area of the storage device.

6. The virtual device migration system according to claim 1, wherein each of the physical devices manages the correspondence between the logical memory address and the physical memory address, using a NORTHBRIDGE in a chipset or a memory management unit installed in an operation device.

7. The virtual device migration system according to claim 1, wherein
a set of network switches is provided for communications through connections between the physical devices via the network, the set of network switches having a function to perform congestion control based on queue management and reduction or zeroization of packet discarding-rate in the connections.

8. The virtual device migration system according to claim 7, wherein
a bridge is provided to convert a first protocol specified for communications through connections via the network, and a second protocol specified for communications between the physical devices and the storage device, the connections via the network being transparent to a software program being executed in the physical devices.

9. The virtual device migration system according to claim 8, wherein
the bridge and the network switches cooperate with each other by using feedback signals from the network switches, the bridge and the network switches providing a function to control a transmission rate and resend discarded packets.

10. The virtual device migration system according to claim 1, wherein
a computer different from the physical devices is connected to the same network as the network being used by the physical devices and the storage device to perform communications or another special-purpose network, and
the computer manages storage areas in computers containing the address mapping information, and manages timings of migrations of virtual devices.

11. The virtual device migration system according to claim 1, wherein mapping of the address mapping information is performed when the computer system is activated, the storage device is read as an input/output device and is mapped in memory areas being managed by the physical devices, and in the mapping, a storage area allowing recognition and registration, and a storage area allowing recognition and registration but having unavailability as an attribute are set in each of the physical devices by using predetermined area allocation information.

12. The virtual device migration system according to claim 11, wherein
the type of the allowing is set in fine grain including only reading or reading and writing.

13. The virtual device migration
system according to claim 1, wherein, when an application program being executed in the physical devices or an application program functioning as the virtual device accesses an area not allowing access, the access is restricted.

14. A virtual device migration system which comprises:
when a virtual device is to be migrated from the first physical device to a second physical device; mapping memory data in a storage device available to the a first physical device, the memory data existing in an area mapped in a main storage of the first physical device; copying the memory data into an area that is registered in the second physical device but is made unavailable to the second physical device; and during a temporary halt of the virtual device, performing a possession right transfer by changing possession right information about availability and unavailability of the storage device so that the area is made unavailable to the first physical device and is made available to the second physical device, thereby dynamically changing settings so that the virtual device can be operated with the use of an arithmetic processing unit of the second physical device.

15. The virtual device migration system according to claim 14, wherein, while copying from the main storage to the storage device is being performed, the virtual device is not stopped, and a synchronizing process is performed by copying only sequentially-rewritten data in the background, when the amount of data rewritten within a period of time required for the copying is determined to have reached a saturation point, simultaneous writing is started not only in the main storage but also in the storage device in response to generation of a process to write data into the area from the virtual device at the same time as difference data copying, and when the synchronization is completed, the mapping of a logical address and a physical address is updated so that the main storage thereafter accesses the storage device, thereby causing the virtual device to continue to operate.

16. The virtual device migration system according to claim 14, wherein, after the possession right transfer is performed, a migrated virtual device that holds the same setting information as that in the virtual device yet to be migrated, and is newly activated in an operation unit in the second physical device accesses virtual device memory data in the storage device, to continue the same operation as that of the virtual device that is operated in the first physical device prior to the migration, and data is migrated from the storage device to the main storage of the second physical device in the same manner as in the migration of the virtual device from the first physical device to the storage device, without a halt of the virtual device.

17. The virtual device migration system according to claim 14, wherein, prior to the possession right transfer, the area in the storage device into which the memory data of the virtual device to be migrated is sequentially written is switched from being unavailable to access from the second physical device to being available only for reading to access from the second physical device, thereby sequentially migrating data into a memory area reserved for the virtual device in the main storage of the second physical device.

18. A management device for migrating a virtual device among a plurality of physical devices, the management device managing the physical devices connected to one another via a network and a storage device that can be accessed by the physical devices, the management device comprising: allocating a storage area of the storage device exclusively to each of the physical devices so that collisions are prevented at the time of access; when the virtual device is migrated from a first one of the physical devices to a second one of the physical devices; mapping memory data in a storage area of a storage device available to the first physical device, the memory data existing in an area mapped in a main storage of the first physical device; copying the memory data into the storage area of the storage device that is registered in the second physical device but is made unavailable to the second physical device; during a temporary halt of the virtual device, performing a possession right transfer by changing possession right information about availability and unavailability of the storage device so that the storage area is made unavailable to the first physical device and is made available to the second physical device, thereby dynamically changing settings so that the virtual device can be operated with the use of an arithmetic processing unit of the second physical device.

19. The management device according to claim 18, wherein, while copying from the main storage into the storage device is being performed, the virtual device is not stopped, and a synchronizing process is performed by copying only sequentially-rewritten data in the background, when the amount of data rewritten within a period of time required for the copying is determined to have reached a saturation point, simultaneous writing is started not only in the main storage but also in the storage device in response to generation of a process to write data into the area from the virtual device at the same time as difference data copying, and when the synchronization is completed, the mapping of a logical address and a physical address is updated so that the main storage thereafter accesses the storage device, thereby causing the virtual device to continue to operate.

20. A virtual device migration method for migrating a virtual device among a plurality of physical devices in a virtualized computer system that includes the physical devices connected to one another via a network and a storage device that can be accessed by the physical devices, wherein each of the physical devices includes a main storage device and is capable of accessing an area in the storage device and the main storage, the area being allocated to each of the physical devices so that collisions are prevented at the time of access to the storage device,
each of the physical devices holds mapping information about logical memory address space information and physical memory address information, the logical memory address space information being generated based on storage areas provided by the main storage device and the storage device, and
the virtual device being operated in one of the physical devices is migrated to another one of the physical devices via the storage device, the mapping information being used in the migration.

21. A virtual device migration method, comprising:
when a virtual device is to be migrated from the first physical device to a second physical device; mapping memory data in a storage device available to the a first physical device, the memory data existing in an area mapped in a main storage device of the first physical device; copying the memory data into an area that is registered in the second physical device but is made unavailable to the second physical device; and during a temporary halt of the virtual device, performing a possession right transfer by changing possession right information about availability and unavailability of the storage device so that the area is made unavailable to the first physical device and is made available to the second physical device, thereby dynamically changing settings so that the virtual device can be operated with the use of an arithmetic processing unit of the second physical device.

22. A management method for migrating a virtual device among a plurality of physical devices, the management is method managing the physical devices connected to one another via a network and a storage device that can be accessed by the physical devices, the management method comprising: allocating a storage area of the storage device exclusively to each of the physical devices so that collisions are prevented at the time of access; when the virtual device is migrated from a first one of the physical devices to a second one of the physical devices, mapping memory data in a storage area of a storage device available to the first physical device, the memory data existing in an area mapped in a main storage device of the first physical device; copying the memory data into the storage area of the storage device that is registered in the second physical device but is made unavailable to the second physical device; and during a temporary halt of the virtual device, performing a possession right transfer by changing possession right information about availability and unavailability of the storage device so that the storage area is made unavailable to the first physical device and is made available to the second physical device, thereby dynamically changing settings so that the virtual device can be operated with the use of an arithmetic processing unit of the second physical device.

23. A non-transitory computer-readable recording medium storing a virtual device migration program for migrating a virtual device among a plurality of physical devices in a virtualized computer system that includes the physical devices connected to one another via a network and a storage device that can be accessed by the physical devices, the virtual device migration program causing a computer to function as one of the physical devices, wherein the physical device includes a main storage and is capable of accessing an area in the storage device as well as the main storage, the area being allocated to each of the physical devices so that collisions are prevented at the time of access to the storage device,
the physical device holds mapping information about logical memory address space information and physical memory address information, the logical memory address space information being generated based on storage areas provided by the main storage and the storage device, and
the physical device migrates the virtual device to another physical device via the high-speed storage device, by using the mapping information.

24. (canceled)

25. A non-transitory computer-readable recording medium storing a management program for migrating a virtual device among a plurality of physical devices, the management program managing the physical devices connected to one another via a network and a storage device that can be accessed by the physical devices, the management program causing a computer to function as a management device to: allocate a storage area of the device exclusively to each of the physical devices so that collisions are prevented at the time of access; when the virtual device is migrated from a first one of the physical devices to a second one of the physical devices, map memory data in a storage area of a storage device available to the first physical device, the memory data existing in an area mapped in a main storage of the first physical device; copy the memory data into the storage area of the storage device that is registered in the second physical device but is made unavailable to the second physical device; and during a temporary halt of the virtual device, perform a possession right transfer by changing possession right information about availability and unavailability of the storage device so that the storage area is made unavailable to the first physical device and is made available to the second physical device, thereby dynamically changing settings so that the virtual device can be operated with the use of an arithmetic processing unit of the second physical device.
